(19) United States
(12) Patent Application Publication
(10) Pub. No.: US 2026/0233211 A1
(43) Pub. Date: Aug. 13, 2026

(54) SUPPORTED PHOTOCATALYST, METHOD OF MAKING AND USES OF THE SAME

(71) Applicants: RUXANDRA VIDU, CITRUS HEIGHTS, CA (US); MARIA RAPA, BUCHAREST (RO); BADRIYAH ALHALAILI, SULAIBIKHAT (KW); OLFA KAMOUN, ARIANA (TN); ECATERINA MATEI, BUCHAREST (RO); ANDRA MIHAELA PREDESCU, BUCHAREST (RO)

(72) Inventors: RUXANDRA VIDU, CITRUS HEIGHTS, CA (US); MARIA RAPA, BUCHAREST (RO); BADRIYAH ALHALAILI, SULAIBIKHAT (KW); OLFA KAMOUN, ARIANA (TN); ECATERINA MATEI, BUCHAREST (RO); ANDRA MIHAELA PREDESCU, BUCHAREST (RO)

(21) Appl. No.: 19/052,250

(22) Filed: Feb. 12, 2025

(51) Int. Cl. B01J 35/39; B01J 23/52; B01J 31/06; B01J 35/33; B01J 37/02; C02F 1/32; C02F 1/72; C02F 101/20

(52) U.S. Cl. CPC B01J 35/39; B01J 23/52; B01J 31/06; B01J 35/33; B01J 37/0244; C02F 1/32; C02F 1/725; C02F 2101/20; C02F 2305/10

(57) ABSTRACT

The present invention relates to a novel supported plasmonic photocatalytic system, specifically a three-dimensional (3D) nanostructured architecture that integrates plasmonic nanocomposites with multi-layer electrospun conductive nanofibers (NFs). The system design enhances the photocatalytic degradation of environmental contaminants, including contaminants of emerging concern and heavy metal ions, under both visible and ultraviolet light. The system employs band gap engineered plasmonic nanocomposites, achieving superior light absorption and charge carrier separation through the formation of Schottky junctions and plasmonic effects. This invention also describes the fabrication method of the 3D supported plasmonic photocatalytic system, as well as its applications in wastewater treatment and filtration, offering a more efficient, stable, and recyclable solution to address the limitations of conventional photocatalysis in environmental decontamination.

### STATEMENT REGARDING FEDERALLY SPONSORED RESEARCH OR DEVELOPMENT

Not Applicable

### FIELD OF THE INVENTION

The present invention relates to the field of photocatalytic materials, and more particularly to supported plasmonic photocatalytic systems engineered for environmental decontamination, including the degradation of harmful pollutants and the filtration of heavy metal ions in wastewater.

### BACKGROUND OF THE INVENTION

Water is vital for life, making its accessibility, affordability, and reliability critical. The fast industrialization period has exacerbated the issue with dangerous pollutants like heavy metal ions and contaminants of emerging concern (CECs), which accumulate and become harmful even in small amounts. Water pollution, caused by pollutants like heavy metal ions and emerging contaminants such as pharmaceuticals and personal care products (PPCPs), poses major ecological and public health challenges. Current water treatment methods are insufficient to effectively remove these pollutants. Traditional photocatalysis shows promise but is inefficient and impractical due to difficulties in recovering powder-based photocatalysts. An effective approach to apply photocatalysis is to suspend nanoscale photocatalyst particles in a solution and expose them to light. This method is low-cost but faces challenges due to low efficiency and severe recombination. The reduction and oxidation sites are often poorly defined, leading to inefficient charge separation and increased recombination within the photocatalysts. The proximity of these sites allows intermediates or products to be re-oxidized or reduced, respectively. Additionally, mixing oxidizing and reducing products (e.g., O₂ and H₂) raises safety concerns and incurs extra costs for separation.

Photocatalysis uses UV light to degrade organic compounds but has limited efficiency as it primarily absorbs ~4% of the solar spectrum. Nanotechnology offers new opportunities with nanoparticles (NPs) providing high surface reaction areas and efficient light utilization. However, practical application remains challenging due to the difficulty in removing and recycling powdered photocatalysts in industrial settings.

CECs are increasingly detected at low levels in surface water, raising concerns about their accumulation and transfer between trophic levels (Almeida, Silva et al. 2020; Gomes, Rocha et al. 2020). The presence, occurrence, fate, transport, and mechanisms of CECs are not fully understood, complicating the assessment of long-term risks to human health and ecosystems. Certain emerging contaminants may have low acute toxicity but cause significant reproductive issues at very low exposure levels. Pharmaceuticals, personal care products, endocrine-disrupting compounds (EDCs), pesticides, polycyclic aromatic hydrocarbons (PAHs), and polychlorinated biphenyls (PCBs) form a new class of CECs that are not routinely monitored. Data shows that only about 150 out of 3,000 pharmaceutical compounds were detected (Nawaz and Sengupta 2019). PPCPs, the broadest category of CECs, are persistent, bioactive, and survive conventional water treatment (Kaur, Hippargi et al. 2019). Examples of CECs and their detection mediums include:
Triclosan [5-chloro-2-(2,4-dichlorophenoxy)-phenol] is present in toothpastes, detergents, shampoos, body washes, deodorants, lotions, and dish washing liquids (Kaur, Hippargi et al. 2019; Hu, Cheng et al. 2017; Behera, Oh et al. 2010; Lee 2015.
Paracetamol, diclofenac, ibuprofen, salicylic acid, furosemide, amoxicillin, ampicillin, clarithromycin, azithromycin, valsartan, irbesartan, telmisartan, carbamazepine, venlafaxine, citalopram, caffeine atenolol, metoprolol pindolol (Papageorgiou, Zioris et al. 2019) are present in analgesics-anti-inflammatories, antibiotics, diuretic, anti-hypertensives, psychiatric drugs, stimulant and beta blockers
2-(2,6-dichloro-aniline) phenylacetic acid (Diclofenac); Ibuprofen; Ketorolac; Pentachlorophenol; Estradiol: (Arguello-Perez, Mendoza-Perez et al. 2019; Zhang, Zhou et al. 2017; Ebele, Abou-Elwafa Abdallah et al. 2017; Kaur, Hippargi et al. 2019) are present in anti-inflammatory drugs.

The impact of low concentrations contaminants on non-target organisms is not evident due to the poor information available on the physical and chemical properties of the target species, and on their behavior in environmental ecosystems. Conventional methods for removing PPCPs, such as biotrickling filters, biofilm reactors, and biological treatments, are inadequate in water and sewage plants (Dey, Bano et al. 2019). Unfortunately, water treatment plants and sewage treatment plants are not properly equipped to remove PPCPs using conventional treatment methods (Kaur, Hippargi et al. 2019). As a result, PPCPs are found in drinking water, posing an increased health risk (Ebele _et al., 2017). Alternative treatments like activated carbon and membrane bio-reactors also show poor results (Nawaz and Sengupta, 2019).

Due to the inexpensive photocatalysis equipment, strong oxidizing capacity, easy control of operation, no secondary pollution and its wide applications, the UV photocatalytic degradation of PPCPs has become a very promising technology.

Metal-oxide nanoparticles are commonly used for photocatalytic applications due to their wide band gap, variety of anisotropic morphologies (Andrade, Nascimento et al. 2017), chemical stability, photocorrosion and photodissolution in most aqueous media (Abisharani, Devikala et al. 2019, Rueda-Marquez, Levchuk et al. 2020). Examples include titanium dioxide (TiO₂), zinc oxide (ZnO), tungsten trioxide (WO₃), iron oxide (Fe₂O₃), tin oxide (SnO₂), cerium oxide (CeO₂), copper oxide (CuO), vanadium oxide (V₂O₅), niobium pentoxide (Nb₂O₅), zirconium oxide (ZrO₂), indium oxide (In₂O₃), and their composites such as titanium dioxide (TiO₂) based composites: TiO₂/ZnO, TiO₂/Fe₂O₃, TiO₂/WO₃, TiO₂/CuO, TiO₂/Bi₂O₃; Zinc oxide (ZnO) based composites: ZnO/Fe₂O₃, ZnO/CuO, ZnO/SnO₂, ZnO/WO₃, ZnO/graphene ZnO—MoS₂; Iron oxide (Fe₂O₃) based composites: Fe₂O₃/TiO₂, Fe₂O₃/ZnO, Fe₂O₃/WO₃, Fe₂O₃/CuO, tungsten trioxide (WO₃) based composites: WO₃/TiO₂, WO₃/ZnO, WO₃/Bi₂O₃, WO₃/MoS₂; bismuth oxide (Bi₂O₃) based composites: Bi₂O₃/TiO₂, Bi₂O₃/ZnO, Bi₂O₃/WO₃, tin oxide (SnO₂) based composites: SnO2/TiO2, SnO₂/ZnO, SnO₂/WO₃; cerium oxide (CeO₂) based composites: CeO₂/TiO₂, CeO₂/ZnO, CeO₂/WO₃. However, current semiconductor photocatalysts cannot degrade organic pollutants under visible light, which represents about 44% of solar energy. This limitation results in low degradation efficiency of CECs, hindering practical applications. Despite advances in nanophotocatalyst materials, these technologies are not yet ready for large-scale use due to low efficiency (Zhang, Wang et al. 2019). Other techniques such as advanced oxidation processes (AOPs) (including ionization, Fenton, Fenton-like and photo-Fenton processes and peroxymonosulfate activation etc) have been developed and coupled with photocatalysis to increase the efficiency of degradation of organic pollutants through free radicals (Kaur, Hippargi et al. 2019). To overcome the limitations of UV light and high carrier recombination rates, as well as to enable photoactivation within the visible spectrum, new photocatalysts with engineered bandgaps have been proposed (Alvarez, Chan et al. 2018). Examples include heterogeneous photocatalysts such as Se-doped ZnO (Shruthi, Shyni et al. 2016) and Ag—ZnO nanoparticles (Liu, Li et al. 2015). The introduction of a Schottky junction at the metal/TiO₂ interface helps suppress recombination between photogenerated holes (h⁺) and photoinduced electrons (e⁻), an effect that is more pronounced when the work function of the metal is higher. In this context, the work function of TiO₂ (4.2 eV) is lower than those of Pt, Pd, and Au, which are 5.65 eV, 5.55 eV, and 5.10 eV, respectively.

Plasmonic photocatalyst has gained significant attention in the scientific community for its potential to extend total oxidation cycles by preventing electron-hole recombination in photocatalytic NPs. Plasmonic photocatalysis enhances chemical reactions using plasmonic materials that can absorb light and generate localized electromagnetic fields. When illuminated by light, these nanoparticles excite surface plasmon resonances (SPR), leading to enhanced photocatalytic activity. This effect improves the efficiency of reactions such as water splitting, carbon dioxide reduction, or pollutant degradation, making plasmonic photocatalysis an emerging field for renewable energy and environmental applications. However, despite their great potential, photocatalytic NPs have not yet been scaled up for industrial applications due to two main challenges: their low efficiency and the difficulty of collection at the end of the treatment through nanofiltration (Capilli, Calza et al. 2019).

These challenges call for new strategies to explore innovative approaches to photocatalyst technologies to eliminate such organic compounds and ensure a sustainable healthy natural environment. The system and the method described herein address these challenges and ensure environmental sustainability.

### BRIEF DESCRIPTION OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention features a 3D supported plasmonic photocatalytic system with a designed architecture, activated by sunlight while minimizing recombination. It comprises multiple layers of conductive nanofibers with varying porosities that support plasmonic nanocomposite in varying quantities. Plasmonic nanocomposites include metal-metal, metal-dielectric, and metal-semiconductor nanostructures. Plasmonic nanocomposites are metals or metal-like materials that can localize light and extend its optical path length.

One embodiment of the present disclosure is to provide a supported plasmonic photocatalytic system with a design that utilizes the synergistic effects of Schottky junctions and surface plasmon effects to enhance visible-light activation, reduce charge recombination, and improve overall degradation efficiency.

This invention proposes a novel supported photocatalytic system featuring a hybrid 3D architecture that combines engineered band gap nanoparticles with conductive electrospun conductive nanofibers. The supported plasmonic photocatalytic system presented in this invention involves modulating energy levels across interfaces in the supported plasmonic photocatalytic system to reduce charge recombination and boost degradation efficiency.

One aspect of this invention is to provide a supported conductive electrospun nanofiber layer, which facilitates precise control of the amount of plasmonic nanocomposites and can be tailored to specific applications. This is achieved using durable support material that provides strong adhesion for nanoparticles, thereby enhancing efficiency in photocatalytic reactions compared to currently available photocatalysts. The strength of conductive electrospun nanofiber layers can be further enhanced by placing them on a base for applications requiring moving parts.

Another aspect of the present disclosure is a controlled porosity of the supported electrospun nanofibers stacking layers, which can be accomplished through the electrospinning process. To control the porosity of electrospun nanofiber layers during the electrospinning process, various key parameters such as polymer concentration in the solution, solvent volatility, applied voltage, flow rate, collector design, relative humidity, and the addition of porogenic agents like salt particles or ice crystals can be used. These parameters of the electrospinning process influence the fiber deposition pattern and create spaces between fibers, thus affecting the overall porosity of the nanofiber mat. These layers, with varying porosities, can be arranged on a base in order of increasing or decreasing porosity. With or without a base, the layers can be assembled back-to-back, with porosity increasing from the middle layers to the sides, or vice versa, forming a double gradient porosity.

Another aspect of the present disclosure is offered by the varying porosity of the electrospun nanofibers stacking layers, which allows for loading with the required plasmonic nanocomposites to promote a controlled and sustained degradation of the pollutants. A composition gradient in the electrospun nanofibers can be attained by loading successive layers of porous material with different amounts of plasmonic nanocomposites and then stacking them to create a gradient of composition across the porous material system.

The present invention describes methods to assemble electrospun nanofibers stacking layers loaded with plasmonic nanocomposites. More particularly, the present invention relates to a method for improving electron transport through the Schottky barrier, enhancing photoconversion efficiency and hydrogen evolution rate under light. The present invention describes various arrangements and staking orders of the loaded layers that can be used in modulated structures for photocatalysis applications.

Another aspect of the present disclosure is offered by the variety of nanocomposites that can be loaded in each electrospun nanofibers layer, allowing for the degradation of diverse pollutants with the 3D supported plasmonic photocatalytic system. Using nanocomposite with a range of compositions, each incorporated into electrospun nanofiber layers, can target different types of pollutants and degrade them simultaneously in real time.

The process of loading nanofibers with plasmonic nanocomposites can be achieved through nanofiber decoration with nanoparticles, which is a process that involves covering nanofibers with nanoparticles to give them new properties. This process can be used to create nanofiber composites with applications in biomedical engineering, catalysis, and more. Nanofiber decoration with nanoparticles can be achieved during electrospinning, when nanoparticles are encapsulated within the nanofibers during their formation, creating composites with enhanced functionalities. Alternatively, the in-situ reduction technique allows for the direct creation of nanoparticles on the nanofiber's surface by reducing a precursor material. Hydrothermal processes further broaden the possibilities, forming nanoparticles on the fibers through controlled thermal conditions. Electrospray, another innovative method, directly deposits nanoparticles onto the nanofiber surface, precisely tailoring their properties for specific applications. Examples can include silver nanoparticles for antibacterial nanofibers for medical applications, Co-Ni alloy nanoparticles embedded in carbon nanofibers as efficient bifunctional oxygen catalysts, NiMoO₄ nanoparticles enhancing glucose sensitivity of carbon nanofibers for glucose sensing, ZnO nanoparticles transforming polymeric nanofibers into effective photocatalysts, and magnetic ferrite nanoparticles endowing cellulose nanofibers with unique magnetic properties.

The present invention describes a 3D supported plasmonic photocatalytic system comprising plasmonic nanocomposites and multiple electrospun conductive nanofibers, and method of making and uses the same. This invention also relates to band gap modulated nano-photocatalytic surfaces used in light-induced processes of photocatalysis, electrolysis and electrovoltaics, and more specifically to induce plasmonic effects to match the solar spectrum for these processes.

The present invention relates to the application of photocatalysis using a 3D architecture of the photocatalyst to enhance photodegradation and decontamination of environmental toxins such as contaminants of emerging concerns, toxic industrial chemicals, chemical warfare agents, bio-pharmaceutics and toxic organic dies. The present invention further relates to the filtration of heavy metal ions through their atomic adsorption using electrospun conductive nanofibers.

Furthermore, by integrating plasmonic nanocomposites in a multifunctional 3D supported plasmonic photocatalytic system to replace the powder form of the photocatalyst, the present invention relates to a method that promotes the efforts for large scale application of photocatalysis, improves the stability and efficiency of hybrid nanocomposite photocatalyst in a wider light spectrum to include visible light, and increases their photocatalytic efficiency and adsorption. Nanofibers typically scatter light due to their small size and structure, while plasmonic nanocomposites can be used to trap light in the semiconductor layer. Nanofiber membranes can achieve high transparency through careful design and material selection by minimizing light scattering. This can be accomplished by controlling fiber diameter and packing density.

### BRIEF DESCRIPTION OF THE FIGURES

Non-limiting embodiments of the present invention will be described by way of example with reference to the accompanying figures, which are schematic and are not intended to be drawn to scale. In the figures, each identical or nearly identical component illustrated is typically labelled. For purposes of clarity, not every component is labeled in every figure, nor is every component of each embodiment of the invention shown where illustration is not necessary to allow those of ordinary skill in the art to understand the invention. In the figures:

FIG. 1 is an illustration of the interfacial charge transfer mechanism in metal/metal-oxide nanoparticle and metal/conductive nanofibers within a nanofiber layer in a supported plasmonic photocatalytic system under light.

FIG. 2 is an illustration of the underlying principles of electrospinning.

FIG. 3 is a flowchart detailing a method of the present invention for making supported plasmonic photocatalytic system.

FIG. 4 is an illustration of the porous material with layers that have increasing porosity from one side to the other.

FIG. 5 is an illustration of the porous material on a fixed base, with layers that have increasing porosity from the base to the exterior.

FIG. 6 is an illustration of the porous material on both sides of a fixed base, with layers that have increasing porosity from the base to the exterior.

FIG. 7.A is an illustration of porous material with layers that have increasing porosity from the inside out.

FIG. 7.B is an illustration of porous material with layers that have decreasing porosity from the inside out.

### DETAILED DESCRIPTION OF THE INVENTION

The present disclosure is directed to a system for and a method of making an improved photocatalysis system using an integrated plasmonic nanocomposites and conductive nanofibers system that will eliminate the need for filtration of powder photocatalyst. The present invention describes subject matters that relate to nanomaterials and nanotechnologies that provide advanced solutions for both filtration and decontamination of wastewaters. The photocatalytic degradation of organic compounds in a multifunctional 3D assembly of nanocomposites and nanofibers will further expand the application of this system to membrane technology and integrative flexible nanodevices.

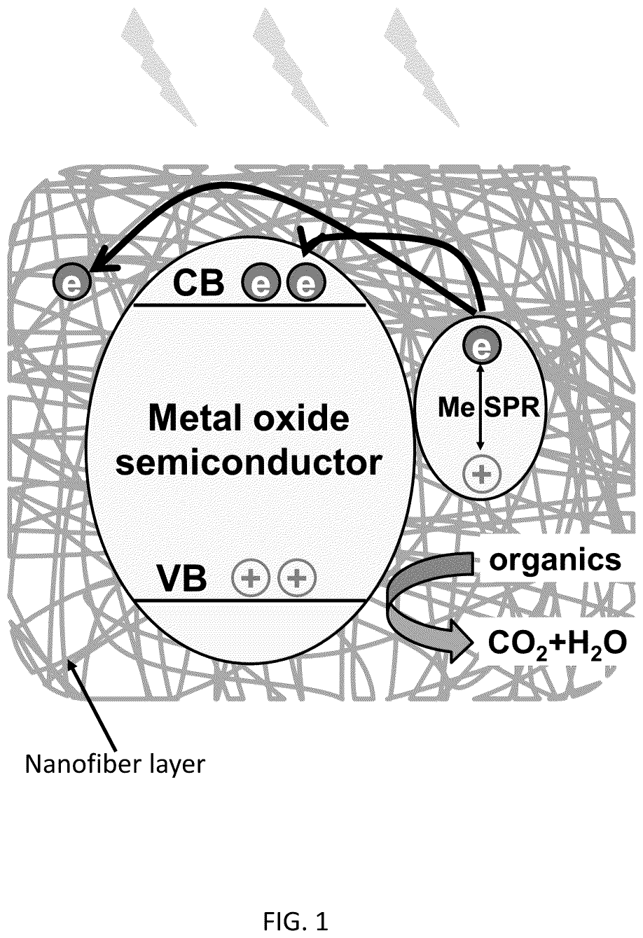

FIG. 1 illustrates the interfacial charge transfer mechanism in metal/metal-oxide nanoparticle and metal/conductive nanofibers within a nanofiber layer, as part of a supported plasmonic photocatalytic system under illumination.

In one embodiment, the enhanced plasmon photocatalysis is driven by interfacial charge transfer in metal/metal-oxide nanoparticles and metal/conductive nanofibers under light, which also reduces recombination. In another embodiment, the supported plasmonic photocatalytic system comprises plasmonic nanocomposites, which typically consist of nanometrical structures made of plasmonic materials such as noble metals (silver, gold, and platinum) or metamaterials. When excited by light at specific wavelengths, the conduction electrons in the metal oscillate collectively. In another embodiment, the plasmonic nanocomposites are formed by Au/TiO₂. There is a potential energy barrier of magnitude ~1 eV (Schottky barrier) at the interface between Au and TiO₂ which will hinder the process of electron injection from Au to TiO₂ on SPR excitation. UV light irradiation the Au would give rise to SPR effect which leads to the intraband excitation, generating energetic electrons whose energy is above 1.0 eV with respect to the Fermi level of Au, which would overcome the Schottky barrier leading to the transfer of electrons to conduction band of TiO₂. In addition, the conductive electrospun nanofibers act as electron-acceptor with a superior conductivity. Conductive electrospun nanofibers can serve as high-surface-area electrodes for electrophotocatalysis and removing heavy metal ions through electrochemical processes or atomic adsorption.

The SPR effect enhances photocatalysis in metal-TiO₂ combination in several significant ways. First, SPR in metals like Au and Ag extends the light absorption range of TiO₂ from the UV to the visible spectrum, making the photocatalytic process more effective under sunlight or artificial light sources. Additionally, SPR generates strong localized electric fields around metal nanoparticles, which increase the excitation of electrons in TiO₂, leading to more efficient charge separation and reduced recombination of electron-hole pairs. Also, the excitation of SPR produces high-energy (hot) electrons in the metal nanoparticles, which can be injected into the conduction band of TiO₂. This enhances photocatalytic activity by increasing the number of charge carriers available for redox reactions. The enhanced local electric fields lead to the generation of more electron-hole pairs and facilitate their separation, boosting photocatalytic efficiency.

Furthermore, the increased number of charge carriers and improved charge separation can lead to higher reaction rates for photocatalytic processes, such as pollutant degradation and hydrogen production. SPR can also influence the selectivity of photocatalytic reactions by providing specific active sites and modifying reaction pathways, as well as increasing the availability of reactive charge carriers for enhanced redox reactions.

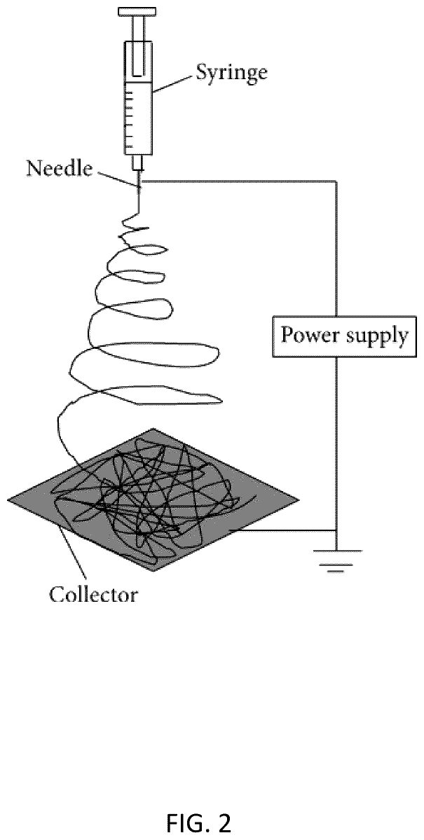

The photocatalyst-supported nanofibers can be obtained using electrospinning process as illustrated in FIG. 2. Electrospinning process uses an electric field to create nanofibers from a polymer solution or melt. The process involves several steps including: i) charging the solution using a high voltage power supply; ii) the electric field causes the solution to deform into a cone shape called a Taylor cone; iii) the electric field stretches the polymer solution, causing it to whip and elongate; iv) the nanofibers are collected on a grounded metal collector plate; v) the nanofiber film is dried and ready for further processing.

Conductive polymeric nanofibers can be created using mono or coaxial electrospinning, which provide a high surface to volume ratio, allowing a higher sorption capacity and use of light. These nanofibers are systematically assembled to form a multilevel structure that supports hybrid nanomaterials, facilitating the integration and regeneration of hybrid nanoparticles.

Conductive polymers such as polyaniline (PANI) and its derivatives such as polythiophene (PTh), polyethelenamine (PEI), polypyrrole (PPy) and their nanocomposites, offer additional benefits due to their ease of synthesis, porous structure, regeneration, non-toxicity, insolubility in water, self-support, environmental and mechanical stability, low cost and potential for the pollutant adsorption, further contributing to the system's effectiveness. By employing advanced materials and architecture, this invention aims to overcome the limitations of existing photocatalytic technologies and provide a scalable, efficient solution for environmental remediation.

Other embodiments of the present invention include the use of polymers that are resistant to UV degradation which include for example cyclic olefin copolymers (COC) such as 10 TOPAS® (see topas. com/uv-transparency), PTFE, e-PTFE, polyvinylidene fluoride, fluorinated ethylene propylene, polyether ether ketone (PEEK), quartz, and other minerals. These polymers can be used in combination with the conductive polymers.

The thickness of a suitable nanofiber polymeric layer can vary from about 10 nm to 100 nm or more, where most porous materials comprising multiple nanofiber polymeric layers have an average thickness in the range of 0.5 to 1 microns. The average thickness numbers represent the average thickness of the total nanofiber layers in a supported plasmonic photocatalytic system. Regardless of fiber production technique or the type of nanofiber used, in one embodiment of the invention, additives (e.g., white pigments such as titanium oxide) may be added to promote diffuse reflection of electromagnetic radiation and for germicidal purposes. Additives could be included with the fiber structures or provided as a coating throughout or on a part of a nanofiber layer.

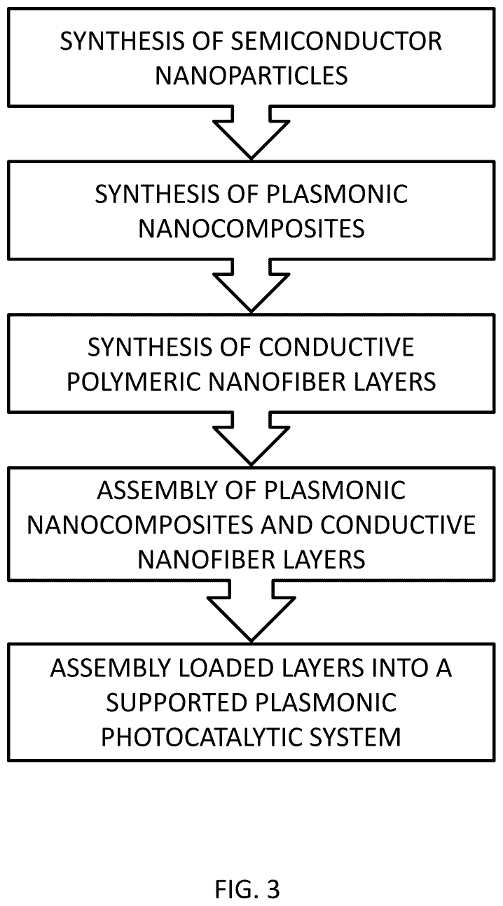

FIG. 3 is a flowchart diagram detailing the present invention for preparing supported plasmonic photocatalytic system. The first step is the synthesis of semiconductor nanoparticles such as metal oxide nanoparticles. The second step is making the plasmonic nanocomposite, which can be made through various methods, depending on the desired morphology and application of the nanocomposite.

In one embodiment, plasmonic nanocomposites are made by coating the metal-oxide semiconductor nanoparticles with a metal that is capable of SPR. The key role of depositing metal on metal-oxide semiconductors is complex. They enhance the photocatalytic efficiency of metal-oxide semiconductors by improving charge separation, reducing recombination of photogenerated electron-hole pairs, and acting as electron traps. Metals like Pd act as electron sinks, facilitating the transfer of electrons and enhancing dehydrogenation reactions. Metals such as Au exhibit surface plasmon resonance, which enhances the local electric field, increases the visible light response, and improves photocatalytic activity. Bimetallic nanoparticles like Au/Pd improve the selectivity for specific reactions, such as hydrogen production from formic acid decomposition. Additionally, metals like Ag provide antimicrobial properties, aiding in the inactivation of bacteria such as E. coli and S. aureus.

The size of the metal deposits affects the electric and potential fields within the space charge region, influencing the photocatalytic efficiency. Deposited metals undergo oxidation by photogenerated holes, and reduction by conduction band electrons, impacting the overall photocatalytic process. Some metals can extend the light absorption range of metal-oxide semiconductors into the visible region, making it more effective under sunlight or artificial light sources. Metals can also provide additional catalytic sites for various reactions, improving the overall efficiency of the photocatalytic process. Moreover, deposited metals facilitate rapid dioxygen reduction to generate reactive free radicals and enable direct excitation of metal nanoparticles, especially under visible light, and facilitate vectorial electron transfer to the metal-oxide semiconductor conduction band. These roles contribute collectively to the enhanced performance of metal-oxide semiconductors in various applications, including energy and environmental applications.

Metal deposition on metal-oxide semiconductor affects charge carrier recombination by acting as electron traps, capturing photogenerated electrons, and preventing recombination with holes. They form Schottky barriers at the metal-semiconductor interface, facilitating charge separation and reducing recombination. Enhancing surface plasmon resonance in metals like Au increases local electric fields and charge carrier generation. Metals, in addition to the conductive nanofibers, provide pathways for rapid electron transfer, reducing recombination rates, and modifying surface properties to reduce recombination sites. They extend light absorption into the visible range, generating more charge carriers and acting as electron sinks, capturing and storing electrons to prevent recombination.

Non-toxic hybrid nanomaterials such as plasmonic nanocomposites can be developed using green methods. While the basis for hybrid nanoparticles is metal oxide semiconductors such as TiO₂ and ZnO, doping and co-doping technologies can be used to create plasmonic nanocomposites with improved adsorption and photocatalytic properties. Various strategies to control the synthesis can be applied to ensure control of the morphology and uniformity in particle size. The Schottky-type junction can be created at the interface between the metal oxide and noble particles (Au, Ag or Pt), which will improve the creation and separation of charge carriers induced by the surface plasmon resonance effect and, consequently, boost the concentration of reactive oxygen species.

The third step is the synthesis of the conductive nanofibers using electrospinning. The electrospinning process can be followed by a post-spinning process to assure that the spun fibers are thoroughly refined and stabilized to enhance their performance characteristics. During this process, the fibers can undergo a series of precisely controlled treatments to optimize strength and elasticity. This alignment is not just a mechanical adjustment, it is a deliberate enhancement of the fiber's inherent properties, ensuring that the final material meets the highest standards of quality and durability. The post-spinning process can also involve thermal treatments, where controlled heat is applied to set the fibers into their new configuration. Heat application must be precise because too little weakens the fibers' resilience, while too much compromises their integrity. Furthermore, chemical treatments can be applied to provide fibers with additional characteristics such as enhanced corrosion resistance. These treatments are tailored to the intended application of the porous material.

In step 4, decorating electrospun nanofibers with nanoparticles takes place, which is a process that requires precision and an understanding of the interactions between the fibers and the nanoparticles. In this step, each layer is loaded with plasmonic nanocomposites in a given amount. Several methods are employed to achieve different distributions and surface coverage such as: post-treatment immersion, ultrasonication, in-situ reduction and electrospraying. Selecting the most appropriate method depends on key factors such as the desired nanoparticle distribution, whether embedded or surface-bound, as well as the stability of the nanoparticles and their interaction with the polymer matrix. In post-treatment immersion, electrospun nanofiber mats are submerged in a nanoparticle solution. This allows the nanoparticles to attach to the fiber surface through electrostatic interactions or chemical bonding, providing a controlled surface decoration. Ultrasonication can be used to facilitate the incorporation of nanoparticles into the nanofiber layer. This method is particularly useful when surface exposure of nanoparticles is desired rather than embedding them within the fiber. A more advanced technique is in-situ reduction, where a nanoparticle precursor is included in the polymer solution. As the fibers form, a chemical reduction reaction takes place, generating nanoparticles directly on the fiber surface. This method ensures strong integration of the nanoparticles while allowing for precise control over their formation. Alternatively, electrospraying can be used to directly deposit nanoparticles onto pre-formed electrospun nanofibers. This approach ensures that the nanoparticles remain on the fiber surface, maximizing their accessibility for catalytic, sensing, or antimicrobial applications.

In step 5, the conductive nanofiber layers loaded with plasmonic nanocomposites are stacked to form the supported plasmonic photocatalytic system. The arrangement of the layers in a stack will follow the porosity gradient. In one embodiment, this system can be sealed on all lateral sides or framed to be used in a photocatalytic tank. In another embodiment, the supported plasmonic photocatalytic system can be attached to a base, a wall or a moving part in a photocatalytic tank.

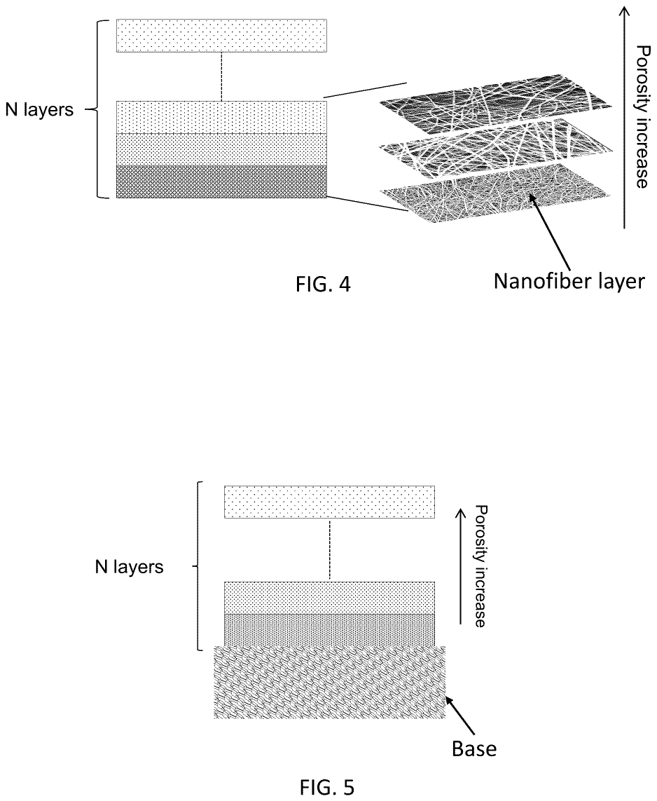

FIGS. 4-7 show various arrangements of the conductive nanofiber layers.

FIG. 4 is an illustration of the porous material with layers that have increasing porosity from one side to the other. In this arrangement, photonic nanocomposites can be loaded in varying amounts into each conductive electrospun layer before stacking. A gradient structure in nanoparticle-loaded electrospun layers ensures an efficient balance between light absorption, charge separation, reactant diffusion, and photocatalytic activity. This design mimics natural hierarchical photocatalytic systems (such as leaf structures in photosynthesis) and leads to significantly improved performance in environmental applications. In photocatalysis, the strategic layering of electrospun fibers, each with different porosities and varying nanoparticle concentrations, plays a crucial role in optimizing performance. Rather than distributing nanoparticles uniformly, a gradient structure allows for more efficient light absorption, controlled reactant diffusion, and enhanced catalytic activity.

In one embodiment, at the surface, the topmost layer can be designed with high porosity and a lower nanoparticle concentration to serve as the first point of interaction. This structure allows light to penetrate deeper into the porous material while ensuring that reactants can easily diffuse through the system. If too many nanoparticles were concentrated at the top, excessive light scattering and shadowing would limit overall efficiency, preventing the deeper layers from contributing effectively to the reaction.

As the reactants move through the system, they encounter progressively denser layers, where nanoparticle concentration increases. These middle layers act as the primary reaction zones, where a balance between porosity and catalytic activity is precisely maintained. This gradient distribution not only ensures that photocatalytic reactions occur efficiently throughout the structure but also facilitates charge carrier transport. When electrons and holes are generated within the nanoparticles, a directional movement toward regions with fewer nanoparticles helps reduce recombination, a major limiting factor in photocatalysis.

Deeper within the system, the bottom layer-characterized by the highest nanoparticle loading and the lowest porosity-acts as the final stage of the reaction. Here, any remaining reactants undergo complete degradation before exiting, maximizing efficiency. This structured approach also prevents the common issue of nanoparticle agglomeration, which can occur when too many nanoparticles are packed into a single region, leading to reduced surface area and diminished reactivity.

FIG. 5 is an illustration of the porous material on a fixed base, with layers that have increasing porosity from the base to the exterior. In this arrangement, the porous material is placed on a fixed base for further stability after stacking the nanocomposites-loaded conductive electrospun layers. This preferred arrangement can be used in photocatalytic tanks with supported photocatalyst directly on the walls or moving parts.

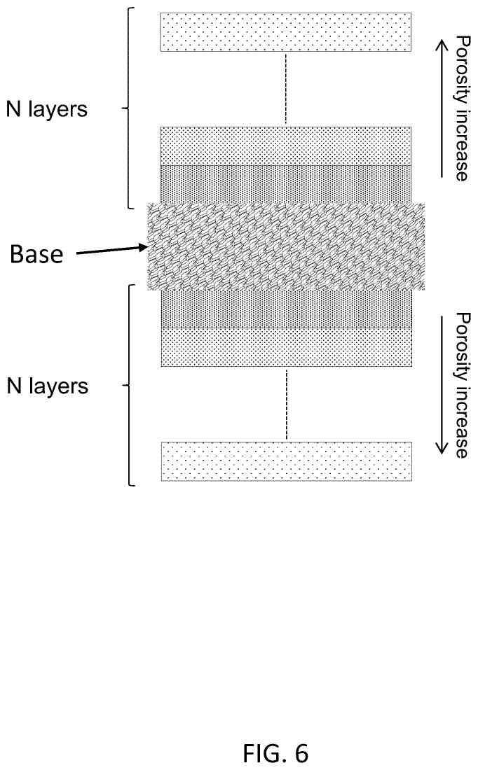

FIG. 6 illustrates a configuration of porous material situated on both sides of a fixed base, with layers exhibiting progressively increasing porosity from the base towards the exterior. In this setup, the porous material is arranged on a fixed base following the stacking of nanocomposites-loaded conductive electrospun layers on both sides of the fixed base. This preferred arrangement is applicable in photocatalytic tanks with supported photocatalyst, where the base functions as either a movable or stationary component, allowing the supported plasmonic photocatalyst system to be illuminated on both sides.

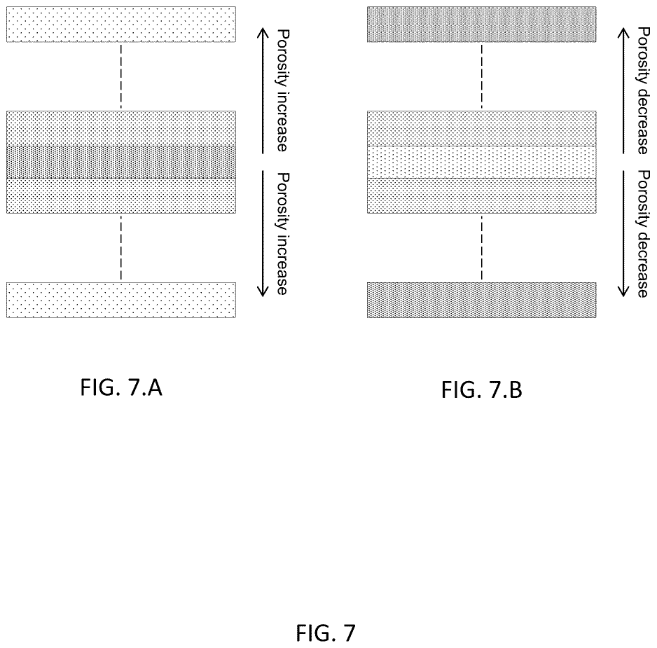

FIGS. 7.A and 7.B illustrate two examples of porous material with successive layers with varying porosities, stacked in a double porosity gradient, either increasing from the inside out (FIG. 7.A) or decreasing from the inside out (FIG. 7.B).

By designing a photocatalytic system where nanoparticle distribution and fiber porosity gradually shift across layers, light can be harnessed more effectively, charge carriers can move efficiently, and reactants can fully interact with catalytic sites. This biomimetic approach, inspired by natural hierarchical structures like those found in plant leaves, enhances performance in applications ranging from environmental remediation to sustainable energy solutions.

Consequently, the conductive nanofiber layers can be loaded with plasmonic nanocomposites following a positive or negative concentration gradient, which can follow or not the porosity gradient. A positive concentration gradient, where the lowest nanoparticle concentration is at the top layer and gradually increases through the deeper layers, is beneficial in specific photocatalytic applications that require longer times for surface reactions or selective product formation. A negative gradient is essential when immediate photocatalytic activity at the surface is required, reactant penetration needs to be controlled, or deeper layers serve a non-catalytic function such as support, durability, or filtration.

A negative concentration gradient, where the highest nanoparticle concentration is at the top layer and gradually decreases through the deeper layers, is beneficial in specific photocatalytic applications that require rapid surface reactions, controlled reactant penetration, or selective product formation. One key scenario where a negative gradient is advantageous is photocatalytic air purification and surface disinfection. In these applications, pollutants or pathogens interact primarily with the outermost layer of the material. By concentrating the nanoparticles at the surface, immediate exposure to UV or visible light activates the photocatalyst, generating reactive species such as hydroxyl radicals and superoxide ions. These species rapidly degrade pollutants or neutralize bacteria and viruses before they have a chance to penetrate deeper into the structure. Since gas-phase reactants have high diffusivity, a deeply embedded catalyst is unnecessary, and focusing activity at the surface maximizes efficiency.

Another case where a negative gradient is useful is in self-cleaning coatings and surfaces. Here, the primary goal is to ensure that contaminants break down upon contact with light without requiring deep penetration. By placing a dense layer of photocatalyst at the surface, light absorption and catalytic activity are maximized where they are needed most. Additionally, this design prevents excessive nanoparticle loss due to abrasion or environmental exposure, improving long-term durability.

In photocatalytic fuel production, such as water splitting or CO2 reduction, a negative gradient can be beneficial when the reaction involves multi-step electron transfer. If the initial reaction step requires high catalytic activity at the surface but secondary reactions occur in a more controlled environment, a top-heavy nanoparticle distribution ensures efficient charge separation while minimizing side reactions deeper in the structure.

A negative gradient can also help in layered filtration systems, where nanoparticles on the top layer degrade harmful compounds before they can clog deeper layers. This is particularly useful in photocatalytic membranes for water treatment, where organic pollutants need to be broken down before reaching the inner structure, preventing fouling and extending the membrane's lifespan.

### REFERENCES

Abisharani, J. M., S. Devikala, R. D. Kumar, M. Arthanareeswari and P. Kamaraj (2019). “Green synthesis of TiO2 Nanoparticles using Cucurbita pepo seeds extract.” Materials Today—Proceedings 14:302-307.
Almeida, A., M. G. Silva, A. Soares and R. Freitas (2020). “Concentrations levels and effects of 17alpha-Ethinylestradiol in freshwater and marine waters and bivalves: A review.” Environmental Research 185.
Alvarez, P. J. J., C. K. Chan, M. Elimelech, N. J. Halas and D. Villagrán (2018). “Emerging opportunities for nanotechnology to enhance water security.” Nature Nanotechnology 13(8): 634-641.
Andrade, G. R. S., C. C. Nascimento, E. C. Silva, D. Mendes and I. F. Gimenez (2017). “ZnO/Au nanocatalysts for enhanced decolorization of an azo dye under solar, UV-A and dark conditions.” Journal of Alloys and Compounds 710:557-566.
Arguello-Perez, M. A., J. A. Mendoza-Perez, A. Tintos-Gomez, E. Ramirez-Ayala, E. Godinez-Dominguez and F. D. Silva-Batiz (2019). “Ecotoxicological Analysis of Emerging Contaminants from Wastewater Discharges in the Coastal Zone of Cihuatlan (Jalisco, Mexico).” Water 11(7).
Behera, S. K., S. Y. Oh and H. S. Park (2010). “Sorption of triclosan onto activated carbon, kaolinite and montmorillonite: Effects of pH, ionic strength, and humic acid.” Journal of Hazardous Materials 179(1-3): 684-691.
Capilli, G., P. Calza, C. Minero and M. Cerruti (2019). “Electrospun core-sheath PAN@PPY nanofibers decorated with ZnO: photo-induced water decontamination enhanced by a semiconducting support.” Journal of Materials Chemistry A 7(46): 26429-26441.
Dey, S., F. Bano and A. Malik (2019). 1—Pharmaceuticals and personal care product (PPCP) contamination—a global discharge inventory. Pharmaceuticals and Personal Care Products: Waste Management and Treatment Technology. M. N. V. Prasad, M. Vithanage and A. Kapley, Butterworth-Heinemann: 1-26.
Ebele, A. J., M. Abou-Elwafa Abdallah and S. Harrad (2017). “Pharmaceuticals and personal care products (PPCPs) in the freshwater aquatic environment.” Emerging Contaminants 3(1): 1-16.
Gomes, M. P., D. C. Rocha, J. C. M. de Brito, D. S. Tavares, R. Z. Marques, P. Soffiatti and B. F. Sant'Anna-Santos (2020). “Emerging contaminants in water used for maize irrigation: Economic and food safety losses associated with ciprofloxacin and glyphosate.” Ecotoxicology and Environmental Safety 196.
Han, Z., V.-W. Chang, X. Wang, T.-T. Lim and L. Hildemann (2013). “Experimental study on visible-light induced photocatalytic oxidation of gaseous formaldehyde by polyester fiber supported photocatalysts.” Chemical Engineering Journal 218:9-18.
Hu, X., Z. Cheng, Z. R. Sun and H. Zhu (2017). “Adsorption of Diclofenac and Triclosan in Aqueous Solution by Purified Multi-Walled Carbon Nanotubes.” Polish Journal of Environmental Studies 26(1): 87-95.
Kaur, H., G. Hippargi, G. R. Pophali and A. K. Bansiwal (2019). 6—Treatment methods for removal of pharmaceuticals and personal care products from domestic wastewater. Pharmaceuticals and Personal Care Products: Waste Management and Treatment Technology. M. N. V. Prasad, M. Vithanage and A. Kapley, Butterworth-Heinemann: 129-150.
Kaur, H., G. Hippargi, G. R. Pophali and A. K. Bansiwal (2019). Treatment methods for removal of pharmaceuticals and personal care products from domestic wastewater. Pharmaceuticals and Personal Care Products: Waste Management and Treatment Technology. Emerging Contaminants and Micro Pollutants. M. V. a. A. K. Majeti Narasimha Vara Prasad: 129-150.
Lee, D. G. (2015). “Removal of a synthetic broad-spectrum antimicrobial agent, triclosan, in wastewater treatment systems: A short review.” Environmental Engineering Research 20(2): 111-120.
Liu, X., W.B. Li, N. Chen, X.X. Xing, C.J. Dong and Y.D. Wang (2015). “Ag—ZnO heterostructure nanoparticles with plasmon-enhanced catalytic degradation for Congo red under visible light.” Rsc Advances 5(43): 34456-34465.
Matei, E., A. Predescu, C. Dragan, C. Pantilimon and C. Predescu (2017). “Characterization of Magnetic Nanoiron Oxides for the Removal of Metal Ions from Aqueous Solution.” Analytical Letters 50(17): 2822-2838.
Matei, E., A. M. Predescu, G. Coman, M. Balanescu, M. Sohaciu, C. Predescu, L. Favier and M. Niculescu (2016). “MAGNETIC NANOPARTICLES USED IN ENVIRONMENTAL ENGINEERING FOR Pb AND Zn REMOVAL.” Environmental Engineering and Management Journal 15(5): 1019-1025.
Matei, E., C. Predescu, A. Badanoiu, A. Predescu and D. Ficai (2015). “APPLICATION OF MAGNETITE NANOPARTICLES AS ADSORBENT FOR Cr, Cd, Ni AND Cu FROM AQUEOUS SOLUTIONS.” Environmental Engineering and Management Journal 14(5): 1001-1010.
Merenda, A., L. X. Kong, B. Zhu, M. C. Duke, S. R. Gray and L. F. Dumee (2019). Functional Nanoporous Titanium Dioxide for Separation Applications: Synthesis Routes and Properties to Performance Analysis.
Najim, T. S. and A. J. Salim (2017). “Polyaniline nanofibers and nanocomposites: Preparation, characterization, and application for Cr(VI) and phosphate ions removal from aqueous solution.” Arabian Journal of Chemistry 10: S3459-S3467.
Nawaz, T. and S. Sengupta (2019). Contaminants of Emerging Concern: Occurrence, Fate, and Remediation. Advances in Water Purification Techniques, Elsevier: 67-114.
Papageorgiou, M., I. Zioris, T. Danis, D. Bikiaris and D. Lambropoulou (2019). “Comprehensive investigation of a wide range of pharmaceuticals and personal care products in urban and hospital wastewaters in Greece.” Science of the Total Environment 694.
Predescu, A., E. Matei, A. Predescu, A. Berbecaru, M. Sohaciu and C. Predescu (2016). “Removal of Hexavalent Chromium from Waters by TiO2—Fe3O4 Nanocomposite.” Environmental Engineering and Management Journal 15(5): 989-994.
Predescu, A. M., E. Matei, A. C. Berbecaru, C. Pantilimon, C. Dragan, R. Vidu, C. Predescu and V. Kuncser (2018). “Synthesis and characterization of dextran-coated iron oxide nanoparticles.” Royal Society Open Science 5(3).
Predescu, A. M., E. Matei, M. Rapa, C. Pantilimon, G. Coman, S. Savin, E. E. Popa and C. Predescu (2019). “Adsorption of Lead(II) from Aqueous Solution Using Chitosan and Polyvinyl Alcohol Blends.” Analytical Letters 52(15): 2365-2392.
Predescu, A. M., E. Matei, D. Savastru, G. Coman, C. Predescu, G. Vlad and L. Favier (2014). “Nanostructures with Iron Oxides Core Applied for Water Treatment.” Digest Journal of Nanomaterials and Biostructures 9(3): 987-995.
Rueda-Marquez, J. J., I. Levchuk, P. F. Ibanez and M. Sillanpaa (2020). “A critical review on application of photocatalysis for toxicity reduction of real wastewaters.” Journal of Cleaner Production 258.
Shruthi, L., Shyni, K. Jagadish and S. Srikantaswamy (2016). “Photocatalytic Degradation And Removal of Heavy Metals in Pharmaceutical Waste by Selenium Doped ZnO Nano Composite Semiconductor.” Journal for Research 2(5): 9.
Zare, E. N., A. Motahari and M. Sillanpaa (2018). “Nanoadsorbents based on conducting polymer nanocomposites with main focus on polyaniline and its derivatives for removal of heavy metal ions/dyes: A review.” Environmental Research 162:173-195.
Zhang, F. B., X. M. Wang, H. N. Liu, C. L. Liu, Y. Wan, Y. Z. Long and Z. Y. Cai (2019). “Recent Advances and Applications of Semiconductor Photocatalytic Technology.” Applied Sciences—Basel 9(12).
Zhang, W., L. Zhou, J. Shi and H. P. Deng (2017). “Fabrication of novel visible-light-driven AgI/g-C3N4 composites with enhanced visible-light photocatalytic activity for diclofenac degradation.” Journal of Colloid and Interface Science 496:167-176.

What is claimed is:

1. A supported plasmonic photocatalytic system comprising:
a porous material comprising multiple polymer layers loaded with photocatalyst nanomaterials of different quantities, wherein the layers are arranged in a porosity gradient;
a photocatalyst immobilized within the porous material; and
a Schottky junction configured to enhance sunlight absorption and increase photocatalytic efficiency.

2. The system according to claim 1, wherein the porous material comprises conductive electrospun polymer nanofibers.

3. The system according to claim 1, wherein the porous material comprises successive layers with varying porosities, stacked in an increasing porosity gradient from one side of the material to the other.

4. The system according to claim 1, wherein the porous material comprises successive layers with varying porosities, stacked in a double porosity gradient, either increasing from the inside out or decreasing from the inside out.

5. The system according to claim 1, wherein said porous material comprises multiple layers formed as solid, hollow or core-shell nanofiber structures.

6. The system according to claim 1, wherein the porous material comprises multiple layers containing immobilized photocatalyst following a positive or negative concentration gradient to create a multi-level structure.

7. The system according to claim 1, wherein the photocatalyst comprises metal-semiconductor nanoparticles designed to absorb photons and transfer electrons to the plasmonic metal during the photocatalysis process.

8. The system according to claim 1, wherein the photocatalyst is a metal engineered to receive electrons from the metal-semiconductor nanoparticles and transfer them to the conductive nanofibers.

9. The system according to claim 1, wherein the photocatalyst is a plasmonic nanocomposite and comprises of metal-metal, metal-dielectric, and metal-semiconductor nanostructures.

10. The system according to claim 1, wherein the photocatalyst is a nanocomposite with a range of compositions, each of which can be incorporated into the electrospun nanofiber layers to target different types of pollutants and degrade them simultaneously in real time.

11. The system of claim 1, wherein the Schottky junction is formed at the interface between metal and semiconductor nanoparticles and between metal and nanofiber layer in the photocatalytic nanocomposite.

12. A method for producing a supported plasmonic photocatalytic system, the method comprising steps of:
synthesizing semiconductor nanoparticles;
synthesizing photonic nanocomposites;
synthesizing multiple conductive polymeric nanofibers with various porosities;
assembling plasmonic nanocomposites and conductive nanofiber layers;
assembling photocatalyst-loaded layers into a supported plasmonic photocatalytic system, wherein layers with different porosities are stacked to form a porosity gradient.

13. The method of claim 12, wherein photonic nanocomposites comprising coating metal-oxide nanoparticles with metals capable of surface plasmon resonance.

14. The method of claim 12, wherein photonic nanocomposites comprising doping nanoparticles to modulate bandgap and improve photocatalytic properties.

15. The method of claim 12, wherein the Schottky junction is created using noble metals capable of surface plasmon resonance.

16. The method of claim 12, wherein synthesizing multiple conductive polymeric nanofibers further includes treating the conductive polymer nanofibers with surface processes to facilitate photonic nanocomposite adhesion.

17. The method of claim 12, wherein plasmonic nanocomposites are loaded in the conductive polymeric nanofiber layers using ultrasonication.

18. The method of claim 12, wherein the assembly of plasmonic nanocomposites and conductive nanofiber layers is prepared by immobilizing plasmonic nanocomposites onto the conductive nanofiber layers to form a multi-level structure with Schottky junctions.
